(19) United States
(12) Patent Application Publication
(10) Pub. No.: US 2011/0129795 A1
(43) Pub. Date: Jun. 2, 2011

(54) DEVICE FOR THE AXIAL RETENTION OF A DENTAL INSTRUMENT EXTREMITY HAVING AN AXIS CROSSED BY AT LEAST ONE LOCKING PIN

(75) Inventor: Jacques Pernot, Vieilley (FR)

(73) Assignee: MICRO MEGA INTERNATIONAL MANUFACTURES (Societe Anonyme), Besancon (FR)

(21) Appl. No.: 12/531,302

(22) PCT Filed: Jan. 25, 2008
(86) PCT No.: PCT/FR2008/050117

§ 371 Date: Jan. 6, 2010

(30) Foreign Application Priority Data
Apr. 17, 2007 (FR) 0754517

(51) Int. Cl. A61C 1/12

(52) U.S. Cl. 433/127

(57) ABSTRACT

The invention relates to a device for axial retention of a dental instrument shank and for transmitting the rotational driving of the instrument. The device is arranged in a head of a contra-angle or handpiece. The shank has an annular groove in which at least one stud is able to engage radially, and a flat permitting rotational driving of the shank. The rotational movement is communicated by an output pinion of a mechanical transmission assembly coupled to a drive motor and arranged in a sleeve joined to the head of the contra-angle. The device is formed by a shaft traversed axially by the instrument shank, at least one elastic lever, and at least one pin. There is cooperation of the pin or pins with the flat provided on the instrument shank.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a device for axial retention of a dental instrument shank and for transmitting the rotational driving of said instrument.

Generally, the element performing these two functions is in the form of a one-piece component having a shank integrally connected to the head of a handpiece, or in the form of a system with a key and transverse disc.

2. Description of Related Art Including Information Disclosed Under 37 CFR 1.97 and 37 CFR 1.98

The prior art includes document WO 99/13794A, which relates to an axial retention device in which the elastic arm is obtained by machining the cylindrical retention shank, such that the two means and the two functions are not separated. This fact complicates production and prohibits interchangeability of the arm or the possibility of making the latter from a material other than that of the shank, for example from a material that is less hard or more elastic.

In addition, the means of connection to the flat of the instrument shank is not dismantlable and is difficult to assemble, since it is an elastic component blocked by a component housed in an open channel and it has to be blocked by welding or adhesive bonding.

### BRIEF SUMMARY OF THE INVENTION

The object of the present invention is to improve the existing devices by facilitating the introduction of the tool and the engagement of its axial retention means, by increasing the transmission of the torque, by facilitating the lapping of the bore intended to receive the instrument shank, by providing a reliable and economic system, and by proposing means that can be dismantled and ensuring better guidance of the instrument.

All these aims are achieved by the invention, which comprises a device for axial retention of a dental instrument shank and for transmitting the rotational driving of said instrument. The device is arranged in a head of a contra-angle or handpiece, said shank having, at its end, an annular groove in which at least one stud is able to engage radially, and a flat designed to permit the rotational driving of said shank. The rotational movement is communicated to the instrument by an output pinion of a mechanical transmission assembly coupled to a drive motor and arranged in a sleeve joined to the head of the contra-angle or of the handpiece. The device is formed by the combination of a shaft that can be traversed axially by the instrument shank, of at least one elastic lever arranged axially in an outer seat of said shaft, and each bearing a stud, and of at least one pin, each arranged in a transverse hole in the upper part of the shaft and offset laterally with respect to the axial direction of the shaft, in such a way as to permit the cooperation of the pin or pins with the flat provided on the instrument shank.

### BRIEF DESCRIPTION OF THE SEVERAL VIEWS OF THE DRAWINGS

The invention will be better understood from the following description and by reference to the attached figures.

FIG. 1 shows a longitudinal section view of the head of a handpiece or contra-angle, being equipped with a device according to the invention for holding the shank of a dental instrument (not seen in sectional view).

FIG. 2 shows a schematic view of one of the components, called the shaft, constituting the retention/drive device according to the invention.

FIG. 3 shows a semi-exploded perspective view of the shaft from FIG. 2, illustrating its position in a ball bearing ring of the head, and its position with respect to a rotational drive pinion.

FIG. 4 shows a schematic view of all the components of FIG. 3, when assembled and seen at another angle, the instrument shank not being depicted.

### DETAILED DESCRIPTION OF THE INVENTION

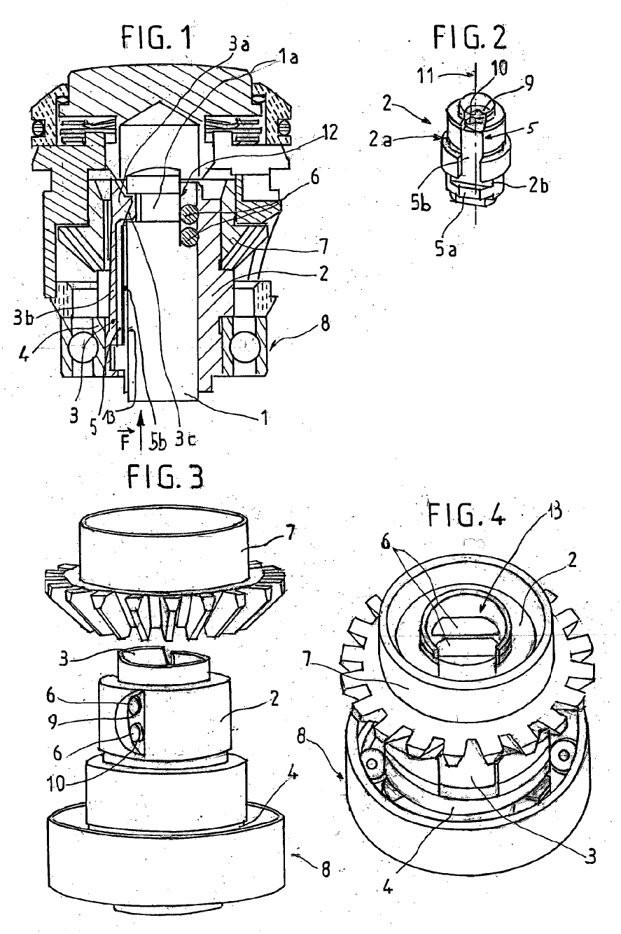

Reference will be made first to FIG. 1, which shows the shank (1) of a dental instrument inserted into the retention/drive instrument according to the invention.

It will be noted that the axial retention of the shank (1) is obtained conventionally by engagement of a stud (3a) of an elastic lever (3) in an annular groove (1a) provided at the end of the shank. (1), and that the rotational driving is provided by virtue of the presence of a flat (12) extending parallel to the axis of the instrument. In an alternative embodiment, there can be several elastic levers (3), each ending with a stud (3a). The characteristics of the annular groove and of the flat are also the subject of a standard.

An elastic lever (3) of elongate shape is housed, parallel to the axis of the shank (1), in a lateral seat (5) of an interface component called shaft (2) and visible in FIGS. 2, 3, and 4.

Said lever (or each lever) is blocked in the lower part between a shoulder (5a) of the shaft (2) and, for example, by an inner ring (4) of a ball bearing of the head, permitting interchangeability of the lever (3).

In an alternative embodiment, provision can be made for the lever or levers (3) to be connected integrally to the shaft (2) by welding, soldering or by other means.

The upper part of a lever has a degree of freedom in a radial direction with respect to the instrument shank A stud (3a) usually has a slope (3c) facilitating the axial introduction of the shank (1) in the direction of the arrow F and the retreat of said stud by spreading of the upper part of the lever or levers (3).

The elasticity of the central part (3b) of a lever 5 returns the stud (3a) towards the shank and engages it in the annular groove (1a).

Preferably, the central part (3b) has to be as long as possible in order to better distribute the fatigue and guarantee a good working life, this in the context of miniaturization of the contra-angle heads.

The shaft (2) of general cylindrical shape (see FIG. 2) has a greater diameter in its central part than at 15 the two ends, in such a way as to create:

above it: a shoulder (2a) serving as a lower axial abutment for a pinion (7) engaged axially on the upper part of the shaft, and

below it: a shoulder (2b) serving as an upper axial abutment for a ball bearing (8).

The shaft (2) is traversed axially by a bore (13), being designed to guide the shank (1) of an instrument. A lateral seat (5) of a lever (3) has a depth less than the thickness of the shaft (2) so as not to open into the bore, except opposite the annular groove (1a) in order to permit engagement of the stud or studs (3a). One (or each) lateral seat (5) thus being on the periphery of the shaft (2) from the means of attachment of the lever (here the shoulder (5a)) and in the direction of the annular groove (2), preferably but not essentially as far as this. Its hollow part permits displacement of the arm (3), and its solid part, or bottom (5b) of the seat, permits guidance of the instrument shank.

The shaft (2) additionally comprises two transverse holes (9 and 10) in its upper part, these being offset laterally with respect to the axial direction (11) of the shaft (2) and each being designed to receive a pin (6) whose length is less than or substantially equal to the diameter of the upper part of the shaft (2). The radial offset is intended to permit engagement of the pins against the flat (12) of the shank (1) and perpendicular to the axial direction (11), the lowest pin coming into abutment in the bottom of the flat (12). The cross section of the holes has a shape complementing the cross section of the pins and a dimension that allows them to slide.

In this way, after engagement of the pins (6), the engagement of the pinion (7) blocks said pins in the shaft (2) (see FIGS. 3 and 4). Of course, a different number of pins could be envisioned without departing from the scope of the invention.

The advantages of the assembly (shaft 2, pins 6, lever 3) described above are the desired advantages, namely:

ease of introduction of the flat of the tool shank by virtue of the cylindrical shape of the pins,

substantial couple transmitted,

ease of lapping the bore containing the drill shank,

ease of assembly,

reliable and economical system,

good guidance of the instrument shank by the shaft (2) by virtue of the fact that this shaft has no axial slot between the annular groove and the point of attachment of the lever.

It will also be noted that one (or each) lever is a component that is produced independently of the shaft (2) and can even be made of a different material, meaning that it is interchangeable, and machining is made easier. In the invention, the central part (3b) of an arm does not come into contact with the instrument shank, and there is a separation between the function of guidance of the shank, which is provided by the unslotted shaft (2), and the function of retention/release provided by the arm or arms.

It will also be noted that the pins are housed in recesses of the shaft (2) and are consequently immobilized in both senses, in a direction parallel to the instrument shank, by the shaft (2) itself, without the need for any blocking component, nor adhesive bonding or welding of a blocking component, as is the case in the prior art document referred to in the introduction. The pins can be withdrawn along the axes of the holes (9 and 10) after removal of the pinion (7). The assembly is therefore completely dismantlable.

Of course, the invention also covers design variants.

1. Device for axial retention of a dental instrument shank and for transmitting rotational driving of the dental instrument, being arranged in a head of a contra-angle or handpiece, the shank having an annular groove at an end thereof, the groove being engaged radially by at least one stud and permitting a flat to rotationally drive the shank, rotational movement being communicated to the instrument by an output pinion of a mechanical transmission assembly coupled to a drive motor and arranged in a sleeve joined to the head of the contra-angle or of the handpiece, said device comprising:
a shaft traversed axially by the instrument shank;
at least one elastic lever manufactured independently from the shaft and arranged axially in an outer seat of said shaft, each lever bearing a stud; and
at least one pin, arranged in a transverse hole in an upper part of the shaft and offset laterally with respect to the axial direction of the shaft, the pin being cooperative with the flat provided on the instrument shank, said shaft having a seat extending longitudinally on the shaft and comprising a bottom extended from an arm-fixing means in a direction of the annular groove.

2. Device according to claim 1, wherein said shaft has a general cylindrical shape and a greater diameter in a central part thereof than a diameter at either of the two ends,
forming a shoulder above, serving as a lower axial abutment for a pinion engaged axially on the upper part of the shaft,
and a shoulder below serving as an upper axial abutment for a ball bearing.

3. Device according to claim 2, wherein each pin has a length smaller than or at most substantially equal to a diameter of an upper part of the shaft engagement of the pinion on the upper part of the shaft blocking the pin in said shaft.

4. Device according to claim 1, further comprising:
a lever being blocked in a lower part between a shoulder of the shaft and an inner ring of a ball bearing of the head, the upper part of the lever having a degree of freedom in a radial direction with respect to the instrument shank, and comprising a stud engaging the annular groove of the shank.
